(19) United States
(12) Patent Application Publication
(10) Pub. No.: US 2004/0056853 A1
(43) Pub. Date: Mar. 25, 2004

(54) Signs using electronically programmable reflective media

(76) Inventors: Bryan Thomas Preas, Palo Alto, CA (US); Helen M. Davis, Cupertino, CA (US); Franklin K. Vest, Santa Clara, CA (US); Russel Allyn Martin, Menlo Park, CA (US)

Correspondence Address: Pepper Hamilton LLP, One Mellon Center, 500 Grant Street, 50th Floor, Pittsburgh, PA, 15219, US

(21) Appl. No.: 10/396,119

(22) Filed: Mar. 25, 2003

Related U.S. Application Data
(60) Provisional application No. 60/367,316, filed on Mar. 25, 2002.

(51) Int. Cl. G09G 5/00

(52) U.S. Cl. 345/204

(57) ABSTRACT

An electronically controllable/programmable sign comprises a multi-layer display device, a display driver for applying at least one field across the image layer in accordance with a display signal, and a controller for providing the display signal to the display driver. The multilayer display device includes at least one image layer. The image layer has one or more regions of reflective media whose reflectivity changes in response to an applied fields. An electronically conductive layer is positioned on one side of the image layer; and a counterelectrode layer is positioned on the other side of the image layer.

### RELATED APPLICATIONS AND CLAIM OF PRIORITY

This application claims priority to, and incorporates by reference, the co-pending U.S. provisional patent application No. 60/367,316, filed Mar. 25, 2002, titled “Signs Using Electronically Programmable, Reflective Media.”

### FIELD OF THE INVENTION

This invention relates to electronically programmable and/or controllable signs. More specifically, this invention relates to programmable signs having multiple regions of reflective media.

### BACKGROUND OF THE INVENTION

Traditional signs have based upon printed materials, paper, plastic, metal, etc., and are therefore not programmable. Accordingly, they are not easily changed. In an attempt to overcome this problem, electronically programmable and/or controllable signs have been in existence. For example, liquid crystal diode (LCD) displays, cathode ray tube (CRT) displays, and other electrically-addressable displays will display an image in response to applied electric signals or fields. However, such signs typically require a large amount of electricity, since they must provide illumination in order to be visible to a viewer.

Other types of displays, such as electrical twisting-cylinder or rotary ball displays, such as those described in U.S. Pat. Nos. 4,126,854 and 4,143,103, incorporated herein by reference in their entirety, have been developed to overcome the problems with previous programmable signs. Twisting-cylinder displays, rotary-ball displays and related displays have numerous advantages over conventional displays, such as LCD and CRT, since they are suitable for viewing in ambient light, they retain an image indefinitely in the absence of an applied electric field, and they can be made to be very lightweight and/or flexible. For further advantages of such displays, see U.S. Pat. No. 5,389,945, incorporated herein by reference in its entirety.

With the development of reflective materials whose reflectivity is controllable by an applied voltage, it became possible to make non-illuminated signs that are programmable. An example of this would be a cholesteric liquid crystal display used for the route sign on a bus, as has been proposed by Kent Display System, of Kent, Ohio. With reflective and programmable material that may be applied to a conductive substrate, one may create a wide variety of sign structures that extend beyond the simple multiplexing used on liquid crystal display. Because the material is reflective, it may be used in any lighting condition, as different from emissive displays.

However, even existing non-illuminated programmable signs have limitations in that they are not small and portable, and thus are not readily suitable for use in retail store sign applications. In addition, existing non-illuminated programmable signs are traditionally single-image signs that do not provide the ability to display and change multiple images.

Accordingly, we have found that it is desirable to provide an improved structure for an electronically programmable sign as described below.

### SUMMARY OF THE INVENTION

An electronically controllable/programmable sign comprises a multi-layer display device, a display driver for applying at least one field across the image layer in accordance with a display signal; and a controller for providing the display signal to the display driver.

The multi-layer display device includes at least one image layer. The image layer has one or more regions of reflective media whose reflectivity changes in response to an applied field. An electronically conductive layer is positioned on one side of the image layer, and a counterelectrode layer is positioned on the other side of the image layer.

In one embodiment, the display device has two image layers. The electronically conductive layer is sandwiched between the image layers, and a counterelectrode layer for each image layer is on the outside of each image layer.

Preferably, the display device has at least two regions of reflective media in the image layer. The regions may be adjacent to one another, or partially or completely overlapping. The reflective media may be rotating balls or cylinders, electrophoretic media or other suitable electrically controllable reflective media. The reflective media may be the same or different from one region to another.

The electrically conductive addressing layer may be patterned to allow the application of locally varying field intensities to the reflective media, to thereby locally change the reflectivity of the media, either across the entire display or region-by-region, to create a single image or multiple display images.

The display image may be as simple as a single region of uniform or uniformly changing reflectivity, or as complex as multiple regions of different levels of image information, from solid areas to flashing areas to areas of alphanumeric symbols, either steady or flashing, to moving images, or any combination of the above. Such images may be provided by a combination of patterning of the conductive layer and appropriate inputs from the controller via the display driver.

### BRIEF DESCRIPTION OF THE DRAWINGS

FIGS. 1A and 1B provide cross-sectional views of various layers that may together form a sign structure.

FIGS. 2A, 2B and 2C illustrate options for forming an image layer having multiple areas to provide a multiple fixed image.

FIGS. 3A, 3B and 3C illustrate possible combinations of multiple image layer regions that may be created under the present invention.

FIGS. 4A and 4B illustrate preferred structures for a one-sided and a two-sided sign, respectively.

FIG. 5 illustrates an alternate one-sided sign structure.

FIG. 6 illustrates a combination of sign structure, driver and controller.

### DETAILED DESCRIPTION OF THE PREFERRED EMBODIMENTS

This invention relates to a novel structure for electronically programmable and/or controllable signs. Preferred structural elements of the sign include a substrate, at least one conductive layer and one or more other layers that include a reflective component. The image is presented on an image layer, which can be integral with or separate from the reflective component. The image can be as simple as a single region or as complicated as a bit-map. Preferably, the material is flexible and may be shaped into any two-dimensional structure.

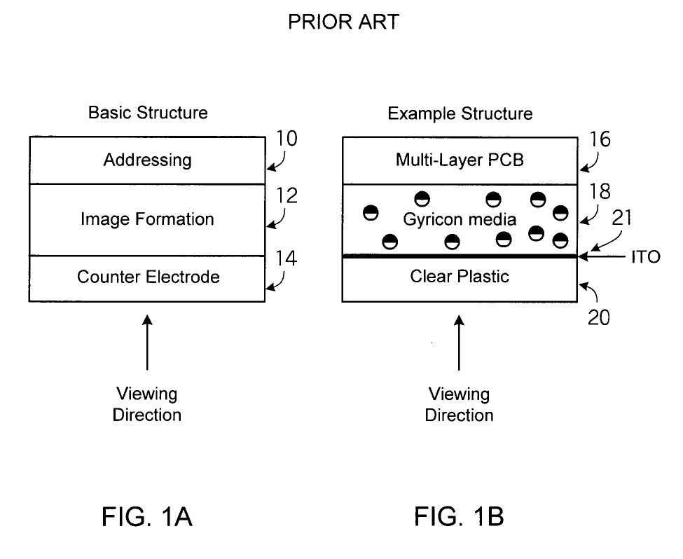

Referring to FIG. 1A, in a preferred embodiment, the sign structure includes a conductive layer 10 for addressing or applying a field, an image formation layer 12 and a counter electrode 14. As illustrated in FIG. 1B, the conductive layer may be, for example, a multi-layer printed circuit board 16 that can apply electric fields in various locations across its surface.

Returning to FIG. 1A, the image formation layer 12 is responsive to an electric field that is applied via conductive layer 10. Thus, when an electric field is applied via conductive layer 10, an image forms on image formation layer 12. If the image formation layer 12 is made of bi-stable material, then the applied electric field may be removed after the sign is programmed by application of an electric field. For example, as illustrated in FIG. 1B, the image formation layer 18 may be made of media containing twisting-cylinder or bichromal balls (such as image formation layers known as SmartPaper™, a trademark of Gyricon Media, Inc.), or it may be made of an electrophoretic material or other material whose reflectivity is modulated by an applied field. This is an advantage because it allows power to be conserved in the sign's operation.

FIGS. 1A and 1B illustrate a structure that may be found in existing SmartPaper™-based displays. A basic structure of a SmartPaper™-based display is shown in U.S. Pat. No. 4,126,854, which is incorporated herein by reference in its entirety.

The counter electrode 14 is typically transparent and conductive, since the counter electrode 14 is positioned between the image formation layer 12 and the viewer. Referring to FIG. 1B, the counter electrode may be made of, for example, indium tin oxide (ITO) 21 on a clear plastic sheet 20. Optionally, element 20 may be made of glass, and element 21 may be made of another material, so long as the counter electrode provides a transparent, conductive layer. As used herein, the term “transparent” is intended to include substantially transparent.

The counter electrode may be a single layer, or it may be a multi-layer construction, for example a printed circuit board (either flexible or rigid). An electric field is applied to the substrate, and the counter electrode may be used to vary the field. In FIGS. 1A and 1B the structure of simple signs is shown, and persons skilled in the art will recognize that additional layers may be provided without departing from the spirit and scope of the invention.

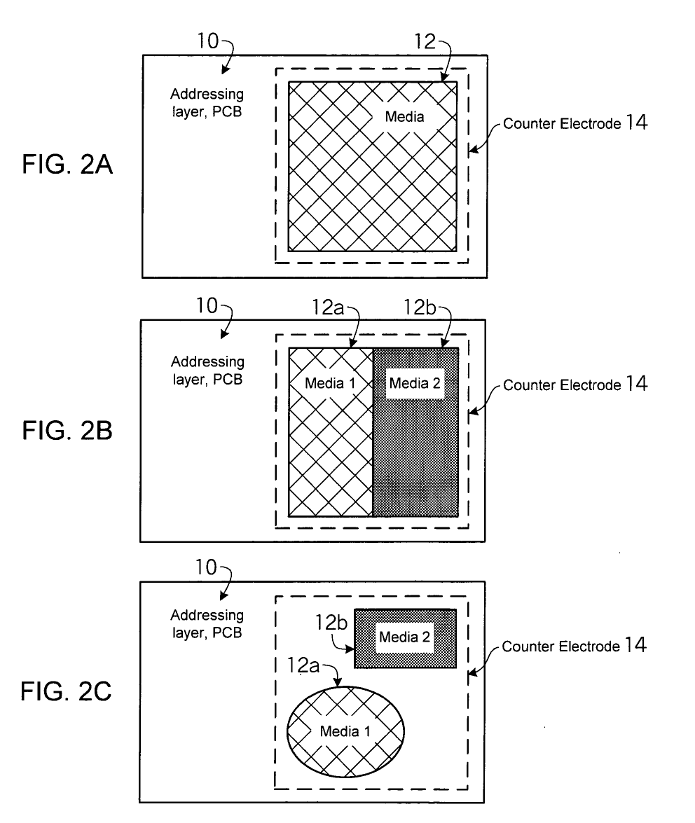

By varying the composition, position and/or size of the image formation layer, various types of signs may be provided. FIGS. 2A through 2C illustrate examples of such signs. For example, referring to FIG. 2A, the image formation layer 12 may be as simple as a single region having uniform reflectivity or uniformly changing reflectivity. Thus, the display may be a simple sign that provides a single image and/or color combination. Alternatively, a complex sign may contain multiple regions and/or different levels of image information. For example, one region may provide a solid area while another region provides a flashing area. One region may provide alphanumeric symbols, while others may provide fixed or moving images. Regions may overlap. The uniform areas may flash to attract attention. They can have transparent or opaque overlays. The regions can be defined by the conductor on the addressing layer or by where the media is placed. The media does not have to be uniform, but may be made up of regions of different properties, for example multiple colors. There might be one region that flashes one color combination (e.g., white and black, in embodiments having bichromal cylinders with a white region and a black region) while a neighboring region flashes another color combination (e.g., black and yellow, in an embodiment having bichromal beads with a black region and a yellow region). Any combination of the above, or other combinations, may occur. Examples of sign structures including multiple regions 12a and 12b in the image layer are illustrated in FIGS. 2B and 2C. Such images may be provided by a combination of patterning of the conductive layer 10 and appropriate inputs from the controller via the display driver.

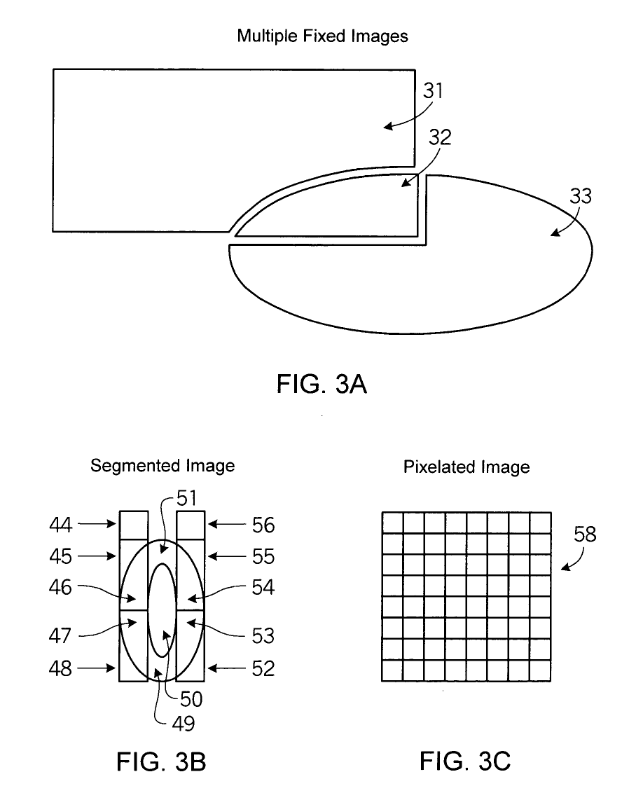

As noted above, multiple images may be created by overlapping two or more images and creating separate regions for the overlaps and the unique regions. This is further illustrated in FIGS. 3A, 3B and 3C. FIG. 3A illustrates an embodiment where the image formation layer includes three distinct area 31, 32, and 33, thus providing a multiple fixed image display. The creation of separate regions may be done by using reflective media having different compositions in each region. Alternatively, and preferably, it may be done by using a single media but varying the electric fields that are applied in the regions. In either embodiment one region is provided at area 31, another region is provided at area 33, and the regions overlap to create a third region at area 32. For example, as illustrated in FIG. 3A, areas 31 and 32 may be combined to form a rectangle. Segments 32 and 33 may be combined to form an ellipse. The multiple fixed image (“MFI”) is a component that may be combined with other elements in a sign.

Characters and numerals form another category of elements that may be incorporated into the sign when the MFI component is provided. One example is lower or upper case characters created from a series of segments. One example would be all the lower case English letters created from 72 segments, 64 of which are independent. Another example would be the Arabic numerals and the dollar sign combined to allow for pricing. Preferably, approximately 128 independent segments are enough to form high quality upper and lower case letters for one font and face, although other numbers of segments are included within the scope of the invention. A simple example is shown in FIG. 3B, where segments 44 to 56 may be combined to form a variety of characters. For example if segments 44, 45, 46, 47, 48, 49, 51, 53 and 54 are driven then the lower case “b” will be displayed. Likewise, if segments 46, 47, 49, 51, 52, 53 and 54 are driven the lower case “a” will be displayed.

Another MFI component, and one that has a wide variety of applications, is a bitmap. A bitmap is a matrix of independently addressable, preferably uniformly distributed, pixel elements that can form any image at its resolution. Essentially, the features provided by a bitmap can be understood if one thinks of a bitmap as analogous to the pixels on a computer display. However, in the present invention a bitmap need not necessarily make up the entire display. If may be incorporated as one element of a larger display, or multiple bitmaps of varying shapes, sizes and resolutions may be provided in a single display. A simple example of a bitmap 58 is shown in FIG. 3C where only a 16×16 group of pixels (i.e., image formation layer components) is shown. Larger or smaller bitmaps, and those with more or fewer pixels, could be used. They could also have various shapes, and are not limited to squares or rectangles.

When the image formation layer is made of twisting-cylinder, rotating-ball or related media, additional options are possible. For example, such media is highly flexible and can therefore be made to conform to a variety of surfaces. To achieve this flexibility, the underlying substrate and the counter electrode material also must be flexible. An example of the use of this is a sign that wraps around a cylindrical column. Such would be the case if ITO and plastic were used to form the counter electrode, as described above. Likewise, the material can be bent around a corner. This could be useful for directing customer into another area of a display. A moving image display would direct the customer's focus, and the bends in the sign would conform to the physical space. When a bichromal display is made using an MFI image formation later, another advantage would be the ability to have regions with different pairs of color. This can be accomplished by laminating one color pair into a gap in a sheet of another color pair. This could be used to provide, for example, a red on white highlight in a black on white sign.

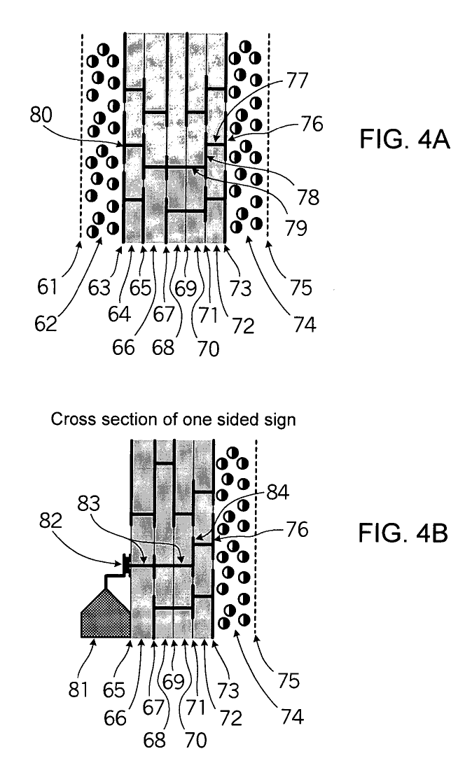

As described in U.S. Pat. Nos. 5,825,529 and 4,126,854, each of which is incorporated herein by reference, twisting-cylinder, rotating ball and related media are sensitive to electric fields. Thus, when a printed circuit board (PCB) is used as the substrate, the underlying interconnections must be shielded. If a via in the PCB exposes an underlying trace, its potential (i.e., the field emanating from the via) could cause a spot to appear on the sign. In a preferred embodiment, this is avoided by providing a substrate structure with buried vias. Examples are shown in FIGS. 4A and 4B. If the image formation layer media is applied to both sides of the PCB (as illustrated in FIG. 4B) then the vias must be buried to avoid exposure on both sides of the substrate. This has the added advantage of balancing the physical structure of the PCB, so that it is less likely to warp.

FIG. 4A shows an embodiment of a sign that is two sided. In this illustration, SmartPaper™ is applied to both sides of the sign. Each sheet of SmartPaper™ is made up of an image layer (62 or 74), in this case bi-chromal beads, and a counter electrode (61 and 75). The PCB is made up of layers of patterned metal (63, 65, 67, 69, 71, 73) and layers of an insulator (64, 66, 68, 70, 72), for example a resin epoxy composite. A segment of the image may be formed by activation of the metal on layers 63 or 73. Segment 76 is connected by via 77 to interconnect 78 on layer 71. The buried via 79 connects interconnect 78 to layer 65. In this example, the circuit continues through to segment 80 on layer 63. Similarly segments on either side could be routed in internal layers 65, 76, 69 and/or 71 to other portions of the PCB. Driver circuits may be placed in the areas of the PCB not covered by SmartPaper™. Thus, activation of the various layers of patterned metal may create a field in the image layer 62 or 74 that corresponds to the size and position of the patterned metal. Because the vias are buried within the layers of insulator, a precise and variable image may be formed. One will recognize that other electro-optically active material may be substituted for the SmartPaper™.

An example cross section of a single sided sign is shown in FIG. 4B. The example has metal layers 65, 67, 69, 71 and 73. Likewise it also has insulator layers 66, 68, 70 and 72. Here, the SmartPaper™, made of image formation layer 74 and counter electrode 75, is only on one side of the PCB. On the other side may be electronic components, such as 81, which is shown as the edge of a surface mount package with contact 82 to the metal of layer 65. Component 81 could be, for example, a Supertex HV507 high voltage driver. The contact 82 is connected through to segment 76. There may be buried vias which go through insulating layers 66, 68 and 70 in one straight path, as indicated by 83. Likewise the interconnections may be made by a series of blind and buried vias such as 84. Thus, activation of the various layers of patterned metal may create a field in the image layer 62 or 74 that corresponds to the size and position of the patterned metal. Again, because the vias are buried within the layers of insulator, a precise and variable image may be formed.

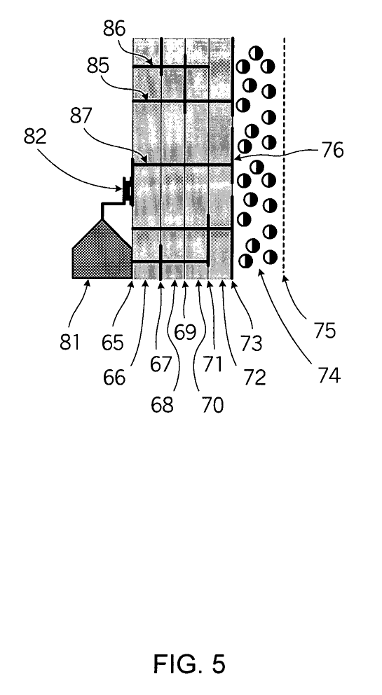

FIG. 5 illustrates another option for the sign structure. This embodiment is similar to that shown in FIG. 4B. However, in this embodiment vias 85 and 87 are provided as “through holes” make the connection from layer 73 through to layer 65 in one straight path. These vias must be plugged such that any liquid in the image formation layer 64 will not leak out of the display material. Other vias, such as 86, will be blind and allow interconnections between metal layers 65, 67, 69 and 71 without any metal being exposed on layer 73. If there were metal from these interconnects on layer 73, the potential on those lines, it would influence the image.

Referring to all of FIGS. 4A, 4B and 5, it is further noted that segments on layers 73 or 63 may have more than one contact and be thereby used to connect the potential from one point to another. This is the function of a jumper to another layer.

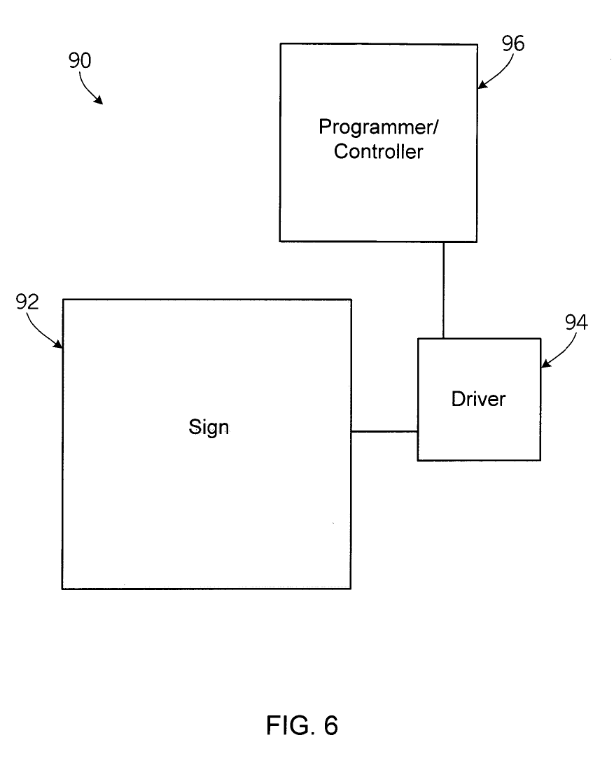

An arrangement to use the electronically controllable/programmable sign 90 described herein is shown in a block diagram in FIG. 6. Sign 90 comprises a multi-layer display device 92, a display driver 94 for applying at least one field across the image layer in accordance with a display signal; and a controller 96 for providing the display signal to the display driver 94. The multi-layer display device is preferably made using the structures described above in FIGS. 1-5, and-the display driver may is used to drive an electric field through the substrate (such as component 81 in FIG. 4B or 5). The controller 96 controls the display signal, and thus the image. Methods for controlling the display signal are described in U.S. provisional patent application No. 60/367,240, titled “Driving Methods for Gyricon Display”, incorporated herein by reference.

The signs described herein have features of low power, flexibility, and ease of use that give them a variety of potential applications in retail. For example, they can be used to attract attention by flashing (i.e., switching between two colors). They can have two or more images that either overlap or are next to each other. The images can change to create the illusion of motion, or to provide a series of messages. The signs can have numerals and symbols to show a characteristic of one or more items for sale in a retail environment, such as the price of an item or items, a discount, a promotion, a rebate, a manufacturer name, or other characteristic. The sign can have alphanumeric characters, composed of segments, to provide messages. And, in complex versions the sign can have bitmapped regions where information is displayed. The image is differentiated from a general-purpose pixel display in that the image is not general in form; it is not a single rectangular bitmapped region. The signs can be placed at the sale display and controlled remotely. They can be made small and portable for easy movement around the store.

The invention is not limited in its application to the details of construction and to the arrangements of the components disclosed herein or illustrated in the drawings. The invention is capable of other embodiments and of being practiced and carried out in various ways. Also, it is to be understood that the phraseology and terminology employed herein is used for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A display system, comprising:
an image layer including one or more regions of reflective media that have a characteristic of reflectivity;
a display driver; and
a controller;
wherein the controller provides a display signal to the display driver, the display driver causes the application an electric field across the image layer in response to the display signal, wherein the electric field is not homogeneous across the image layer so that at least one region of the reflective media exhibits a response that is different from the response of at least one other region of the reflective media.

2. The display system of claim 1 further comprising a substrate and a conductive layer, wherein the image layer is positioned between the substrate and the conductive layer.

3. The display system of claim 2 wherein the conductive layer is patterned to enable the application of locally varying electric field intensities to the regions.

4. The display system of claim 1 wherein a plurality of the regions of reflective media are arranged to form a bit map.

5. The display system of claim 1 wherein two or more of the regions overlap to form at least one overlapping region.

6. The display system of claim 1, further comprising:
a second image layer;
a substrate located between the two image layers; and
conductor layers located outside the two image layers.

7. The display system of claim 1 wherein the image layer is flexible and may conform to a three-dimensional position.

8. The display system of claim 1 wherein the responses create an image in the image layer, the response being indicative of a characteristic of an item for sale in a retail environment.

9. A multi-layer display device, comprising:
a substrate comprised of a conductive material;
an addressing layer;
a multi-region image layer of reflective media positioned between the substrate and the addressing layer, wherein each region exhibits a characteristic of reflectivity; and
a driver;
wherein the driver creates an electric field between the substrate and the addressing layer, and an image is formed in the image layer in response to the electric field having locally varying field intensities in at least two regions in the image layer.

10. The display device of claim 9 wherein the substrate comprises a plurality of patterned metal segments and a plurality of insulating segments, wherein at least a portion of the metal segments in the plurality of patterned metal segments are electrically connected to the image layer.

11. The display device of claim 10 wherein the insulating segments focus the application of an electric field onto the image layer by the patterned metal segments.

12. The display system of claim 9 wherein the device is flexible and may be shaped to conform to a three-dimensional shape.

13. The display system of claim 9 further comprising:
a second multi-region image layer of reflective media, positioned so that the substrate is located between the two image layers; and
a second addressing layer positioned outside of the second image layer.

14. The display system of claim 9 wherein the image is indicative of a characteristic of an item for sale in a retail environment.

15. The display system of claim 9 wherein the addressing layer comprises a transparent conductive material.

16. A display system, comprising:
a substrate comprised of a plurality of patterned metal segments and a plurality of insulating segments;
a multi-region image layer of reflective media, wherein each region exhibits a characteristic of reflectivity, and wherein at least a portion of the segments in the plurality of patterned metal segments in the substrate are electrically connected to the image layer; and
a driver;
wherein the driver creates an electric field between the substrate and the addressing layer, and an image is formed in the image layer in response to the electric field by having locally varying field intensities in at least two regions in the image layer.

17. The display system of claim 16 further comprising an addressing layer comprised of a transparent conductive material, wherein the multi-region image layer is positioned between the substrate and the image layer.

18. The display system of claim 16 further comprising:
a second multi-region image layer of reflective media, wherein the substrate is positioned between the two image layers; and
two addressing layers, each positioned outside of an image layer.

19. The display system of claim 16 wherein the substrate and image layer are flexible.

20. The display system of claim 16 wherein the image is indicative of a characteristic of an item for sale in a retail environment.
